(19) United States
(12) Patent Application Publication
(10) Pub. No.: US 2021/0208018 A1
(43) Pub. Date: Jul. 8, 2021

(54) SENSOR-EMBEDDED GASKET FOR REAL-TIME MONITORING

(71) Applicant: LGC US ASSET HOLDINGS, LLC, Houston, TX (US)

(72) Inventors: DALE NORMAN, HOUSTON, TX (US); CUONG PHAN, HOUSTON, TX (US)

(21) Appl. No.: 17/111,057

(22) Filed: Dec. 3, 2020

Related U.S. Application Data
(60) Provisional application No. 62/943,452, filed on Dec. 4, 2019.

(51) Int. Cl. G01M 3/02; G01L 1/24

(52) U.S. Cl. CPC G01M 3/02; G01L 1/242

(57) ABSTRACT

A gasket with embedded sensors configured for direct measurement of compression. Individual sensors may be mounted on one or more strips of conductive material wherein the strips of material are disposed around the circumference of the gasket. The outer circumferential face of the gasket may feature a groove to accommodate the strips of material having sensors mounted thereon.

### CITATION TO PRIOR APPLICATIONS

The present application is a continuation of and claims priority to U.S. Provisional Application No. 62/943,452, titled “SENSOR-EMBEDDED GASKET FOR REAL-TIME MONITORING” and filed Dec. 4, 2019.

### TECHNICAL FIELD

The present invention relates generally to gaskets and, more particularly, to an improved gasket for positioning between and sealing the facings of opposing conduit flanges. More specifically, the gasket is formed so as to allow for positioning of sensor to detect changes in condition on the gasket itself, so as to enable inline monitoring systems without the need for ports or indirect measurements at the flange connections.

### BACKGROUND

Any bolted joint experiences relaxation and load loss after initial tightening. The ability to monitor and, potentially, compensate for this load loss is critical to maintaining the viability of that fastened junction. Numerous gasket designs, including some of those noted herein, provide various structural elements in an attempt to address these effects. However, to date, the inventor is unaware of any integrated gasket product that determines the amount of initial compression/deflection sustained by a gasket once the flange connection is made, nor is there a means of actively monitoring the connection in real time to determine if it is being worked loose due to such things as thermal cycles on the connection. In fact, manual monitoring of bolt tension is labor intensive and, therefore, not routinely or regularly done.

Thus, a flange connection that actively monitors changes in compression would be welcome within the industry. Notably, while some installation bolts provide this function upon the initial compression load being applied, they lack the ability to provide updates over time. Further, the positioning of the gasket itself makes it a more ideal vehicle, to the extent that appropriate sensors can be integrated within a design that is still capable of withstanding compression and thermal stresses common to gasket installations.

Previous structures have been proposed whereby pressure sensors and other monitoring equipment can be incorporated into a radial port away from the main pipeline (e.g., U.S. Pat. No. 6,606,912). Still other proposals suggested positioning sensors within a cuff-like fitting that surrounds the joint section (e.g., U.S. Pat. No. 10,422,449). Neither of these proposals are ideal to the extent that they require significant additional structure, above and beyond the gasket that is usually positioned between the joint connection.

As background on gasket designs, United States Patent Publications 2018/0328491; 2017/0074437; and 2017/0276249, as well as U.S. Pat. Nos. 10,198,200; 9,976,680; 9,285,062; 5,823,542; 5,794,946; 5,664,791; 4,127,277; and 4,059,215, are all incorporated by reference herein.

A gasket that can accommodate integrated sensors without substantially departing from its role as a sealing element would be welcome. Further, a gasket having sensors that allow for direct detection of changes to the gasket, rather than the joint/flange, would provide a more reliable and potentially useful monitoring system. Lastly, a sensor-embedded gasket that can be handled and treated no differently than a conventional gasket when joining fittings would be particularly welcome.

### SUMMARY

A gasket having embedded compression sensors is contemplated. Additional functionality is provided to allow for the seamless communication between this sensor and other networked monitoring devices.

Specific reference is made to the appended claims, drawings, and description, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIG. 1 is a top plan view of the gasket, including the slotted guide ring, according to certain embodiments of the invention.

FIG. 2 is a cross sectional side view of the gasket of FIG. 1 taken along line A-A.

FIG. 3 is a cross sectional detail side view of Detail B in FIG. 2.

FIG. 4 is a top plan view of the sensor strip including a plurality of sensors, prior to being formed or embedded into the gasket.

FIG. 5 is a sectional detail top view of one sensor, as identified in Detail C in FIG. 4.

FIG. 6 is a perspective isolated schematic view of the basic shape the sensor strip will assume when inserted into the circumferential groove of the gasket of FIG. 1.

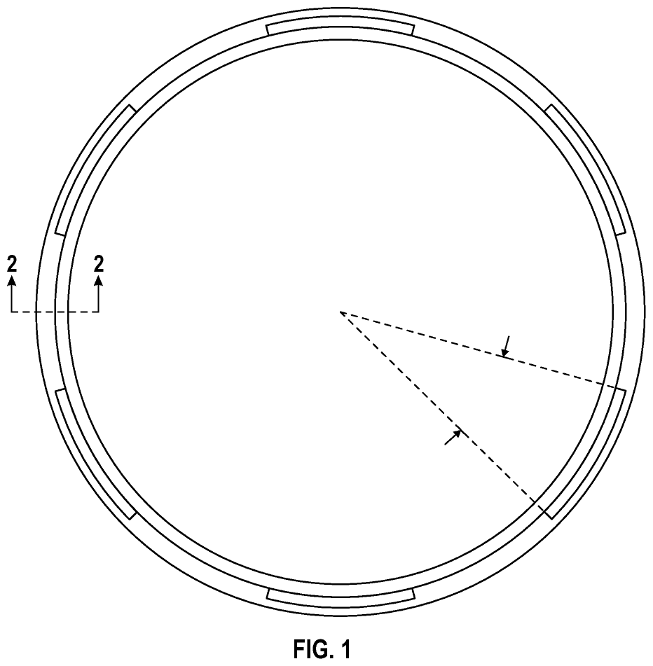

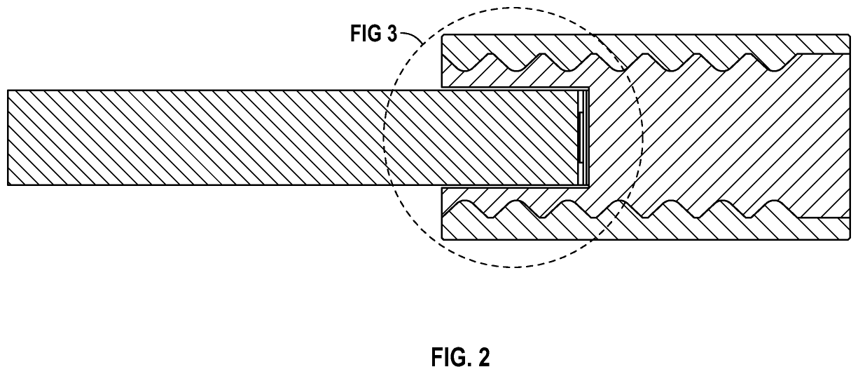

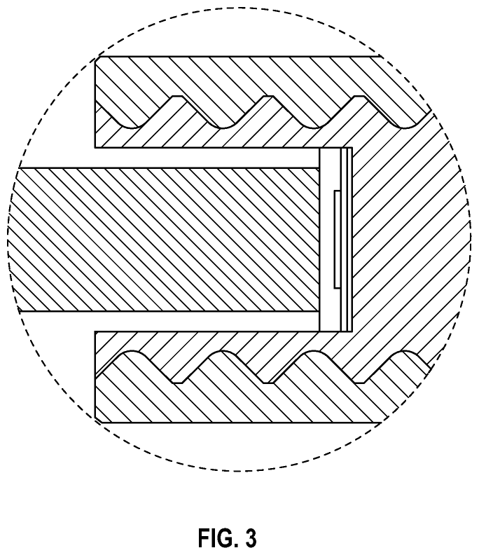

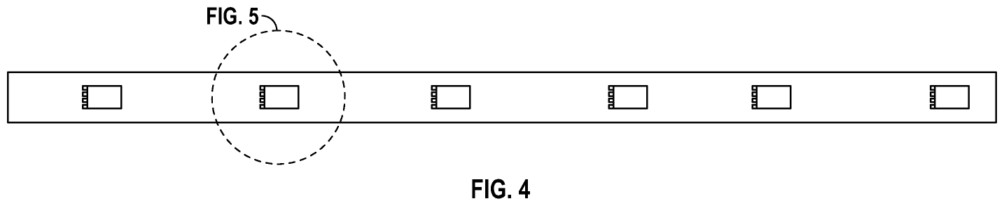

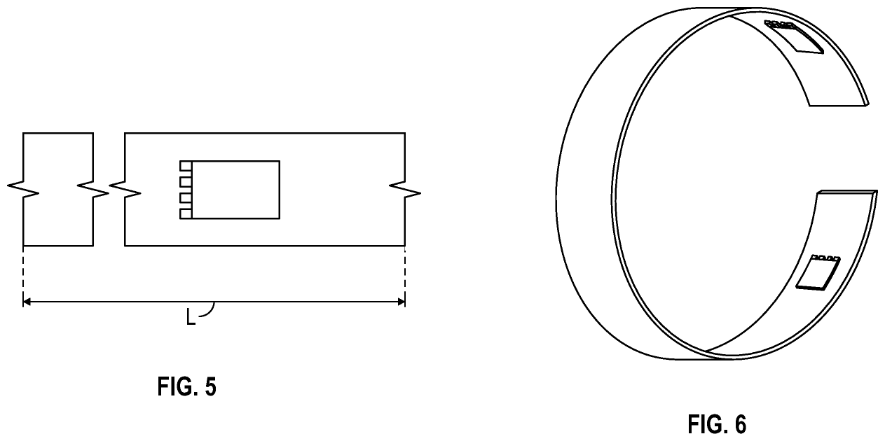

### DESCRIPTION OF INVENTION

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

A gasket with one or more embedded sensor is contemplated. Such gaskets monitor the amount of strain, and particularly forces exerted in the radial direction, experience by the gasket, hence giving an indication of the likely sealing of the gasket, as well as monitor it over time, to see if the likelihood of leaking is developing over time. More generally, these observations will directly monitor the amount of compression, strain, and/or stress exerted on the gasket, both initially and over time. Because the sensors are mounted on a circumferential facing of the gasket as it sits in-line within the installation, these sensors provide a more direct indication of the forces within the pipe and, more specifically, the forces being exerted on the gasket and the pipe sections immediately proximate to that gasket.

Although a small sensor would be required in the smaller end of the space, fiber optic sensors provide an ideal solution. The possible use of fiber optic sensors (possibly FBC or other type) as is used for down hole and other oil and gas applications. However, other types of sensors could be substituted or added. By way of non-limiting example, pressure sensors, strain gauges, temperature sensors, and the like could be employed in a coordinated manner to provide significant data about the gasket and the conditions immediately proximate to that sensor (or set of sensors).

Further, these sensors can be deployed along the entire circumference of the pipe. In this manner, if one radial section of the pipe/gasket is experiencing unique conditions in comparison to the other sensors on the remaining radial sections of that part of the pipe/gasket, a simple comparison of readings from the sensors in that gasket will indicate anomalies. Further, if the gaskets are positioned in a uniform manner relative to one another (or other steps are taken to index and position the sensors in the same orientation from one gasket to another along a length of pipe), further information can be gleaned as to the performance of the pipe as a whole, including regions of stress, strain, and the like.

The sensors may be mounted to a thin metal strip. Preferably, the sensor (or group of sensors) are distributed evenly, so that when the strip is fitted with the gasket, each sensed location is uniformly spaced along the circumference of that gasket. As noted above, it is further preferred if a plurality of gaskets are provided with the same number and orientation of the gaskets so as to allow for data to be collected on a larger and more meaningful scale.

The mounting strip is preferably made from a conductive material. In this manner power and/or signals could be transmitted via the strip. Embedded wires and/or etching could be employed to achieve these same goals. The strip may extend around substantially the entire circumference of the gasket.

Notably, the sensor is monitoring the load of the media within tube itself (or other conditions specific to the inner radius of the gasket that is exposed to the tube) insofar as the gasket seals a joint that is direct contact with such loads. In this manner, it presents a distinct advantage by providing effectively direct readings of the load, including location and changes over time. In this manner, it is believed a more accurate indication of the load is being provided.

In some embodiments, the sensors are fitted with wireless transmission capabilities. Wireless technologies, including radio frequency identification, near-field communications devices and protocols, and magnetic, capacitive, inductive, or other non-contact detection systems could be provided on or with the sensors to serve the goals defined herein. In these embodiments, the sensor needs only to be proximate to a detector (e.g., an end user's hand held or mobile computing device). The detector itself then displays or otherwise communicates information captured by the wireless technology. Further, by aggregating the data and associating with specific gaskets and/or locations, a more robust understanding of the pipe, and the stress and strain therein, can be achieved.

In recent years, the increased functionality of portable electronics (i.e. mobile phones and tablet PCs) has enabled such devices to be used as readers for communicating with such wireless communication tags. As an example, Near Field Communication (NFC) tags, Radio Frequency Identification (RFID) tags, and Bluetooth communication devices all enable installers, technicians, and/or master controllers to gather data and discern performance using mobile phones or other ubiquitous computing devices (e.g., laptops, etc.) outfitted with appropriate applications. Generally speaking, NFC devices require readers to be positioned relatively close to the scanner (˜20 cm), whereas RFID and Bluetooth can be effective at much greater distances. Other wireless protocols could be used.

In some embodiments, so-called “passive” sensors could be used so that an external power source is not needed. When a passive sensors receives an electromagnetic (EM) signal from a nearby reader device, a portion of the energy of the signal is converted into a current, thereby powering (and activating) the tag. Passive tags are therefore only capable of transmitting information when activated by a nearby reader device.

Still further, some or all of the sensors could be hardwired, as implied above. Here, power and/or output signals would be delivered along dedicated pathways formed by or integrated with the mounting strip. These pathways could be modularly connected along the axial length of the installation so as to connected gaskets along an entire length of the installation.

The gasket itself may be any type of solid core gasket, including the types identified above. Metal core gaskets are seen as particularly amenable to certain aspects of the invention. As seen in the figures, a guide ring can be affixed. The guide ring preferably presents a slotted, notched, or serrated profile along its inner annulus, so as to only make connection to the gasket a selected number of points. This arrangement leaves a portion of the outer circumferential facing of the gasket accessible.

A groove or channel is formed along that outer circumferential facing. The channel is wide enough to receive one or more mounting strips carrying one or more sensors as described above. The strip is held in place by a force-fitting, adhesive, fasteners, or other known means. The inner “prongs” of the guide ring may come into contact with the strip in order to keep it positioned.

Preferably, the strip is as thin as possible, so as to provide a direct comparison against the forces being exerted along its inner facing by the gasket. The strip should also be constructed from materials that can withstand environmental conditions common to the installation (in terms of heat, humidity, chemical environment/exposure, and the like).

In some embodiments, it may be possible to position sensors in the channel and/or on the gasket circumference without the need for a mounting strip. However, in this instance, care should be taken to ensure the sensors stays in its desired position and receives and provides the desired inputs (e.g., power) and outputs (e.g., signal). An elastomer or other inert and/or protective material could be used to “back-fill” the channel to keep the sensor in place.

Similarly, a protective coating could be layered on top of the mounting strip after it has been fitted to the gasket.

Also, the mounting strip could be sized to fit around the entire circumference or less than the entire circumference of the gasket. A plurality of segmented separate strips could be provided within a single channel

In some embodiments, the depth of the groove or channel (i.e., its radial depth) may be approximately one half the axial thickness of the core of the gasket. Further dimensional information can be gleaned from the Figures, and this disclosure specifically embraces any pertinent ratios that can be calculated therefrom. Further still, ranges of +/− 5%, 10%, 20%, and up to 25% are embraced relative to the information in the Figures. Further still, these figures may be scaled to other common gasket diameters and/or thicknesses.

In certain embodiments, the gaskets may be formed in the “kammprofile” style. The upper and lower surfaces may also be coated with materials, such as graphite and the like, to impart desired sealing performance.

The gaskets illustrated and described herein may have any size, although 4″ gaskets are envisioned as particularly useful. Any form of wired or wireless communication can be employed to retrieve data from the sensors. In the same manner, an energizing source, such as a battery or other sources of electrical power/current may be employed or provided to the installation.

A method of monitoring a pipe is also contemplated. Here, a plurality of one or any combination of the gaskets described above are installed between pipe sections. Data is collected to establish an initial condition of each gasket in the installation, as well as the overall condition of the installation. Data is then monitored over time, with changes in individual gaskets and/or the entire installation being representative of the need for inspection, maintenance, replacement of parts, and the like. The data may be managed and processed by the reader device, or it may be transmitted remote (e.g., via a network and/or the world wide web) to a centralized location for analysis. Sections of the installation may be hardwired so as to minimize the data collection locations and/or to allow for fully remote monitoring via a non-wireless connection.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A gasket comprising:
a substantially annular core having an inner circumferential face and an outer circumferential face; and
a sensor element configured for engagement with said outer circumferential face.

2. The gasket of claim 1 further comprising a mounting groove formed into said outer circumferential face, wherein said sensor element is disposed with said mounting groove.

3. The gasket of claim 2 wherein said sensor element comprises at least one sensor and at least one mounting strip, wherein said at least one sensor is coupled to said at least one mounting strip.

4. The gasket of claim 3 wherein said mounting strip is composed of a conductive material.

5. The gasket of claim 4 wherein said sensor element is further configured for wireless transmission of sensor data.

6. The gasket of claim 5 further comprising an outer guide ring positioned radially outward relative said outer circumferential face.
